(19) United States
(12) Patent Application Publication
(10) Pub. No.: US 2026/0155096 A1
(43) Pub. Date: Jun. 4, 2026

(54) DISPLAY DRIVING METHOD, DISPLAY DRIVING DEVICE, AND DISPLAY APPARATUS

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventors: Zheng Bao, Beijing (CN); Lian Xiang, Beijing (CN); Xing Yao, Beijing (CN); Mingqiang Wang, Beijing (CN); Gong Chen, Beijing (CN); Xueying He, Beijing (CN); Chang Wang, Beijing (CN); Yuan Fang, Beijing (CN); Haotian Yang, Beijing (CN); Jiaxiang Zhang, Beijing (CN)

(21) Appl. No.: 18/696,963

(22) PCT Filed: Jul. 31, 2023
(86) PCT No.: PCT/CN2023/110181

§ 371 Date: Mar. 28, 2024

(51) Int. Cl. G09G 3/3225; G09G 3/3266

(52) U.S. Cl. CPC G09G 3/3225; G09G 3/3266; G09G 2320/0233; G09G 2320/045; G09G 2320/064

(57) ABSTRACT

A display driving device, a display driving method and a display apparatus relate to the field of display technology. The display driving device includes a display driving chip The display driving chip includes: a first register; a plurality of pins; and a processing circuit configured to: write a duration of a first level of a gate trigger signal corresponding to a display mode information into the first register wherein the gate trigger signal jumps from the first level to a second level at an end time of the first level; generate the gate trigger signal based on the duration stored in the first register acquire a reference voltage corresponding to the duration; and output the gate trigger signal and the reference voltage through the plurality of pins.

### CROSS REFERENCE TO RELATED APPLICATION(S)

This application is a Section 371 National Stage Application of International Application No. PCT/CN 2023/110181, filed on Jul. 31, 2023, entitled “DISPLAY DRIVING METHOD, DISPLAY DRIVING DEVICE, AND DISPLAY APPARATUS”, which is incorporated herein by reference in its entirety.

### TECHNICAL FIELD

The present disclosure relates to a field of display technology, and in particular to a display driving method, a display driving device, and a display apparatus.

### BACKGROUND

A display apparatus (e.g., OLED display) may include a display panel, a gate driver, and a display driving chip. The display panel contains a pixel circuit including a plurality of pixels, and the display driving chip inputs a trigger signal to a gate driving circuit, so that a driving signal generated by the gate driver is provided to the pixel circuit.

In a process of driving the pixel circuit, a threshold voltage drift of a driving transistor in the pixel circuit may cause an image retention, which may affect a display effect of the display panel.

### SUMMARY

The present disclosure provides a display driving method, a display driving device, and a display apparatus.

According to a first aspect, the present disclosure provides a display driving device, including: a display driving chip, including: a first register; a plurality of pins; and a processing circuit configured to: write a duration of a first level of a gate trigger signal into the first register, where the duration of the first level of the gate trigger signal corresponds to a display mode information, and the gate trigger signal jumps from the first level to a second level at an end time of the first level; generate the gate trigger signal based on the duration stored in the first register; acquire a reference voltage corresponding to the duration; and output the gate trigger signal and the reference voltage through the plurality of pins.

For example, the processing circuit is further configured to: receive a display mode switching request through the plurality of pins, where the display mode switching request contains a target display mode; read a current duration of the first level of the gate trigger signal from the first register; write a target duration corresponding to the target display mode into the first register in response to determining that the target duration is different from the current duration; and generate the gate trigger signal based on the target duration stored in the first register.

For example, the processing circuit is further configured to: receive a display mode switching request through the plurality of pins, where the display mode switching request contains a target display mode; read a current duration of the first level of the gate trigger signal from the first register; and generate the gate trigger signal based on the current duration stored in the first register, in response to determining that a target duration corresponding to the target display mode is consistent with the current duration.

For example, the display driving chip further includes a second register configured to store a second duration; the first register is further configured to store a first duration less than the second duration; and the processing circuit is further configured to: receive a display mode switching request through the plurality of pins, where the display mode switching request contains a target display mode; generate the gate trigger signal based on the first duration stored in the first register, in response to determining that the target display mode is a high brightness monitor mode; and generate the gate trigger signal based on the second duration stored in the second register, in response to determining that the target display mode is an always on display mode.

For example, the display driving chip further includes a first storage unit configured to store the reference voltage; and the processing circuit is further configured to read the reference voltage corresponding to the duration from the first storage unit.

For example, the display driving device further includes a second storage unit configured to store a reference voltage; and the processing circuit is further configured to read the reference voltage corresponding to the duration from the second storage unit.

For example, the second storage unit is further configured to store the duration of the first level of the gate trigger signal corresponding to the display mode information; and the processing circuit is further configured to read the duration from the second storage unit and write the duration into the first register.

For example, the duration is greater than or equal to a reference time difference; and in I scanning cycles, a time difference between a start time of a first level of a clock signal in a first scanning cycle and an end time of the first level of the clock signal in an I^{th} scanning cycle is the reference time difference, where I is an integer greater than 1.

For example, the processing circuit is further configured to: write a first duration into the first register in response to determining that the display mode information is a high brightness monitor mode; and write a second duration into the first register in response to determining that the display mode information is an always on display mode; where the second duration is greater than the first duration.

For example, the processing circuit is further configured to: write the first duration into the first register in response to determining that the display mode information is a normal mode.

For example, the first duration is greater than or equal to a first reference time difference, and the second duration is greater than or equal to a second reference time difference; and in M scanning cycles, a time difference between a start time of a first level of a clock signal in a first scanning cycle and an end time of the first level of the clock signal in an M^{th} scanning cycle is the first reference time difference; and in N scanning cycles, a time difference between a start time of the first level of the clock signal in a first scanning cycle and an end time of the first level of the clock signal in an N^{th} scanning cycle is the second reference time difference, where M<N, and M and N are integers greater than 1.

According to a second aspect, the present disclosure provides a display driving method for driving a pixel circuit, including: setting a duration of a first level of a gate trigger signal according to a display mode information, where the gate trigger signal jumps from the first level to a second level at an end time of the first level; acquiring a reference voltage corresponding to the duration; and driving the pixel circuit through the gate trigger signal and the reference voltage.

For example, the duration is greater than or equal to a reference time difference; and in I scanning cycles, a time difference between a start time of a first level of a clock signal in a first scanning cycle and an end time of the first level of the clock signal in an I^{th} scanning cycle is the reference time difference, where I is an integer greater than 1.

For example, the display mode information includes a high brightness monitor mode and an always on display mode, and the duration includes a first duration and a second duration; the setting a duration of a first level of a gate trigger signal according to a display mode information includes: setting the duration as the first duration in response to determining that the display mode information is the high brightness monitor mode; and setting the duration as the second duration in response to determining that the display mode information is the always on display mode; where the second duration is greater than the first duration.

For example, the display mode information further includes a normal mode; the setting a duration of a first level of a gate trigger signal according to a display mode information further includes: setting the duration as the first duration in response to determining that the display mode information is the normal mode.

For example, the first duration is greater than or equal to a first reference time difference, and the second duration is greater than or equal to a second reference time difference; and in M scanning cycles, a time difference between a start time of a first level of a clock signal in a first scanning cycle and an end time of the first level of the clock signal in an M^{th} scanning cycle is the first reference time difference; and in N scanning cycles, a time difference between a start time of a first level of a clock signal in a first scanning cycle and an end time of the first level of the clock signal in an N^{th} scanning cycle is the second reference time difference, where M<N, and M and N are integers greater than 1.

For example, the setting a duration of a first level of a gate trigger signal according to a display mode information includes: acquiring a current duration of the first level of the gate trigger signal and a target display mode contained in a display mode switching request, in response to the display mode switching request being received; and modifying the current duration to a target duration corresponding to the target display mode, in response to determining that the target duration is different from the current duration.

For example, the setting a duration of a first level of a gate trigger signal according to a display mode information includes: acquiring a current duration of the first level of the gate trigger signal and a target display mode contained in a display mode switching request, in response to the display mode switching request being received; and maintaining the current duration in response to determining that a target duration corresponding to the target display mode is consistent with the current duration.

For example, the driving the pixel circuit through the gate trigger signal and the reference voltage includes: generating a gate driving signal according to the gate trigger signal; generating a driving voltage according to the reference voltage; and driving the pixel circuit through the gate driving signal and the driving voltage.

For example, the duration is greater than or equal to a gate time difference; and in I scanning cycles, a time difference between a start time of a first level of the gate driving signal in a first scanning cycle and an end time of the first level of the gate driving signal in an I^{th} scanning cycle is the gate time difference.

According to a third aspect, the present disclosure provides a display apparatus, including: a display panel; and the display driving device provided by the embodiments of the present disclosure, where the display driving device is configured to drive the display panel.

### BRIEF DESCRIPTION OF THE DRAWINGS

FIG. 1A shows a schematic structural diagram of an example pixel circuit;

FIG. 1B shows a signal timing of the pixel circuit in FIG. 1A;

FIG. 2 shows a schematic structural diagram of a display driving device according to an embodiment of the present disclosure;

FIG. 3 shows a schematic structural diagram of a display apparatus according to an embodiment of the present disclosure;

FIG. 4A shows a signal timing according to an embodiment of the present disclosure;

FIG. 4B shows a signal timing according to another embodiment of the present disclosure;

FIG. 4C shows a signal timing according to still another embodiment of the present disclosure;

FIG. 5 shows a signal timing according to yet another embodiment of the present disclosure;

FIG. 6 shows a schematic structural diagram of a display driving device according to another embodiment of the present disclosure;

FIG. 7 shows a schematic structural diagram of a display driving device according to still another embodiment of the present disclosure;

FIG. 8 shows a schematic structural diagram of a display driving device according to yet another embodiment of the present disclosure;

FIG. 9 shows a schematic structural diagram of a display apparatus according to an embodiment of the present disclosure; and

FIG. 10 shows a flowchart of a display driving method according to an embodiment of the present disclosure.

### DETAILED DESCRIPTION OF EMBODIMENTS

In order to make objectives, technical solutions and advantages of the present disclosure clearer, the technical solutions in the embodiments of present disclosure are clearly and completely described below with reference to the drawings in the embodiments of the present disclosure. Obviously, the described embodiments are only a part but not all of the embodiments of the present disclosure. Based on the described embodiments of the present disclosure, all additional embodiments obtained by those ordinary skilled in the art without carrying out any inventive effort fall within the protection scope of the present disclosure. It should be noted that throughout the drawings, the same elements are represented by the same or similar reference numerals. In the following descriptions, some specific embodiments are just used for descriptive purposes and should not be construed as limiting the present disclosure, but rather examples of the embodiments of the present disclosure. When it is possible to cause confusion in understanding of the present disclosure, conventional structures or configurations will be omitted. It should be noted that shapes and sizes of components in the drawings do not reflect actual sizes and ratios, but just illustrate contents of the embodiments of the present disclosure.

Unless otherwise defined, technical or scientific terms used in the embodiments of the present disclosure should have usual meanings understood by those skilled in the art. The words “first,” “second,” and the like used in the embodiments of the present disclosure do not indicate any order, quantity or importance, but are just used to distinguish different composition parts.

Furthermore, in the description of the embodiments of the present disclosure, the terms “interconnected” or “connected to” may refer to two components being connected directly, or may refer to two components being connected through one or more other components. In addition, the two components may be connected or coupled in wired or wireless manner.

It should be noted that in the description of the embodiments of the present disclosure, a symbol Vdata may represent either a data signal or a level of the data signal. Similarly, a symbol Gate may represent either a gate driving signal or a level of the gate driving signal, a symbol VINT may represent either a predetermined initial voltage terminal or a voltage of an initial signal, and a symbol ELVDD may represent either a power supply or a power voltage provided by the power supply. The above applies to all the following embodiments and will not be repeated.

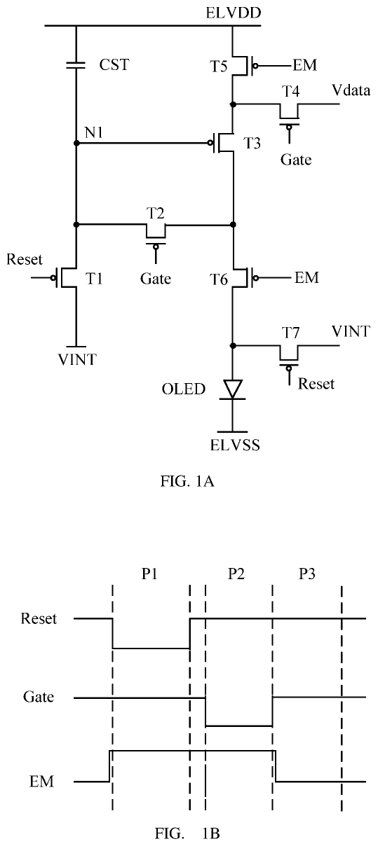

An active matrix organic light emitting diode (AMOLED) display panel may provide a brighter image with higher contrast, and a flexible AMOLED display panel may be used in a display screen of a wearable electronic product. A pixel unit of a pixel circuit of the AMOLED display panel may have a 7T1C structure, that is, each pixel unit includes seven thin film transistors TFT and one capacitor C, as shown in FIG. 1.

FIG. 1A shows a schematic structural diagram of an example pixel circuit. FIG. 1B shows a signal timing of the pixel circuit in FIG. 1A.

In the example of FIG. 1A, transistors T1 to T7 may be P-type transistors.

In the example of FIG. 1B, in an initialization phase P1, a level of a reset signal Reset is a low level. In a data writing phase P2, a level of a gate driving signal Gate is a low level. In a light emission phase, a level of a light emission control signal EM is a low level.

In the initialization phase P1, the transistor T1 is turned on under the control of the low level of the reset signal Reset. An initialization signal VINT initializes a gate electrode of the driving transistor T3 so that a gate electrode of the driving transistor T3 is initialized to VINT, while a storage capacitor CST is charged. At this time, a voltage at a node N1 is VINT.

Under the control of the low level of the reset signal Reset, the transistor T7 is turned on, and the initialization signal VINT is written into an anode of a light emitting element OLED along an initialization path from a predetermined initial voltage terminal to the light emitting element OLED, so that an anode voltage of the light emitting element OLED is initialized to VINT. In this way, a residual charge of the anode of the light emitting element OLED may be released, so that a residual voltage of the anode of the light emitting element OLED is eliminated.

In the data writing phase P2, the transistors T2 and T4 are turned on under the control of the low level of the gate driving signal Gate. The driving transistor T3 is turned on under the driving of a voltage signal stored in the storage capacitor CST. A data signal Vdata is written from a data signal terminal into the node N1 via the transistors T4, T3 and T2. At this time, the data signal Vdata may charge the storage capacitor CST, and the driving transistor T3 is gradually turned off. When Vgs=Vg−Vs=Vg−Vdata≥Vth, the driving transistor T3 is turned off, and the charging of the storage capacitor CST is completed. At this time, a potential at the node N1 is Vg=Vth+Vdata.

It may be understood that Vth is a threshold voltage of the driving transistor T3, Vgs is a gate-source voltage of the driving transistor T3, Vg is a gate voltage of the driving transistor T3, and Vs is a source voltage of the driving transistor T3. A voltage difference (VINT−ELVSS) between the initial signal terminal VINT and a second power supply terminal ELVSS should be less than the threshold voltage Vth of the light emitting element OLED, so that the light emitting element OLED may not emit light in the data writing phase.

In the light emission phase P3, the transistors T5 and T6 are turned on under the control of the low level of the light emission control signal EM. At this time, the driving transistor T3 has a source potential Vs=Vdd and a gate potential Vg=Vth+Vdata, Vgs=Vth+Vdata−Vdd<Vth, and the driving transistor T3 is turned on under the driving of the voltage signal stored in the storage capacitor CST. The transistor T5 and the transistor T6 are turned on, and the voltage of the first power supply terminal ELVDD is written into the circuit. A driving current is applied to the light emitting element OLED along a light emitting path from the power supply to the light emitting element OLED via the transistor T5, the driving transistor T3 and the transistor T6, to drive the light emitting element OLED to emit light. At this time, a current flowing through a pixel is Id=A(Vdd−Vdata)2, where A is a constant. The 7T1C circuit may eliminate a Vth difference between different pixel units, and improve a brightness uniformity of the display panel.

When initializing the anode of the light emitting element OLED, an incomplete initialization of the anode of the light emitting element OLED may be caused by the affection of the voltage of the second power supply terminal ELVSS, resulting in an abnormal display brightness of the light emitting element OLED and thus affecting a picture display. In addition, a long-term application of voltage to the gate electrode of the driving transistor T3 may cause a threshold voltage drift of the driving transistor T3, which may cause an image retention.

For the problem of image retention in a display picture, the present disclosure provides a display driving device including a display driving chip. The display driving chip includes: a first register; a plurality of pins; and a processing circuit configured to: write a duration of a first level of a gate trigger signal corresponding to a display mode information into the first register; generate the gate trigger signal based on the duration stored in the first register; acquire a reference voltage corresponding to the duration; and output the gate trigger signal and the reference voltage through the plurality of pins.

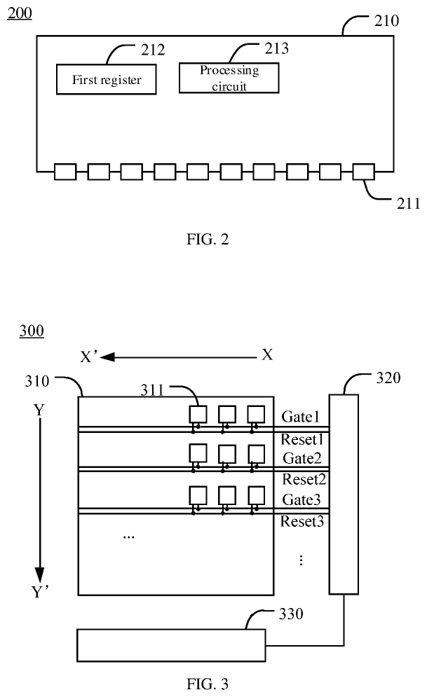

FIG. 2 shows a schematic structural diagram of a display driving device according to an embodiment of the present disclosure.

As shown in FIG. 2, a display driving device 200 may include a display driving chip 210.

In the embodiments of the present disclosure, the display driving chip 210 includes a plurality of pins 211, a first register 212, and a processing circuit 213. For example, the display driving chip 210 may be a drive integrated circuit (DIC).

In the embodiments of the present disclosure, the processing circuit 213 writes a duration of a first level of a gate trigger signal corresponding to a display mode information into the first register 212, and generates the gate trigger signal based on the duration stored in the first register 212. The processing circuit 213 acquires a reference voltage corresponding to the duration, and outputs the gate trigger signal and the reference voltage through the plurality of pins 211.

For example, the pixel circuit in the display panel may be driven by the gate trigger signal and the reference voltage output by the processing circuit 213.

For example, at an end time of the first level, the gate trigger signal jumps from the first level to a second level. For example, the first level may be greater than the second level, such as the first level being a high level and the second level being a low level. For example, the first level may also be less than the second level, such as the first level being a low level and the second level being a high level.

For example, when a low level of the reset signal Reset serves as a valid level for turning on the transistor(s) of the pixel unit, the first level may be a low level, and the second level may be a high level. When a high level of the reset signal Reset is used as a valid level for turning on the transistor(s) of the pixel unit, the first level may be a high level, and the second level may be a low level.

For example, the display mode information is a display mode of the display panel. For example, the display mode information may include a normal mode, a high brightness monitor (HBM) mode, and an always on display (AOD) mode.

When the display panel is in use, the normal mode or the HBM mode may be employed to display a complex picture. For example, when a user browses information through the display panel, the display panel may be set to the normal mode or the HBM mode. When the display panel is in a standby mode, the AOD mode may be employed to display a simple picture. For example, when the display panel is not used by the user, the display panel may only display a simple wallpaper picture or a static picture. For example, the display panel may only display a clock picture, and a background of the clock picture may be a solid color background. For example, a digital dial or an analog dial may be displayed on the solid color background.

For example, the processing circuit 213 may control, through the gate trigger signal, a gate driver on array (GOA) circuit to generate a gate driving signal Gate and a reset signal Reset, and control an on/off state of a transistor in each row of pixel units based on the gate driving signal Gate and the reset signal Reset, so that the light emitting element in the pixel circuit may be driven to emit light. For example, the processing circuit 213 may output the gate trigger signal to the GOA circuit, and the GOA circuit may receive the gate trigger signal and output the gate driving signal Gate and the reset signal Reset.

By setting the duration of the first level of the gate trigger signal, it is possible to control the durations of the first levels of the gate driving signal Gate and the reset signal Reset output by the GOA circuit, so as to control a time of initializing the anode of the light emitting element OLED and a time of applying a voltage to the gate electrode of the driving transistor, and then improve an initialization state of the light emitting element and a voltage application time for the gate electrode of the driving transistor.

For example, since the normal mode and the HBM mode are used to display a complex picture, the AOD mode is used to display a simple picture, and different display brightness should be provided for different types of display pictures, it is desired for the processing circuit 213 to have display brightness for a plurality of display modes respectively so as to display a corresponding type of picture.

For example, the reference voltage may be a gamma voltage. It is possible to obtain gamma voltages corresponding to a plurality of durations in advance by Gamma tuning, so as to determine a corresponding relationship between display mode, duration and Gamma voltage.

The reference voltage may include an upper limit gamma voltage and a lower limit gamma voltage. A source driving circuit may convert received image data into a data signal Vdata based on the upper limit gamma voltage and the lower limit gamma voltage. By setting the gamma voltage corresponding to the duration, it is possible to obtain the data voltage Vdata corresponding to the gate driving signal Gate and the reset signal Reset. Accordingly, under the driving of the gate driving signal Gate, the reset signal Reset and the data signal Vdata, a picture may be displayed with proper display brightness in different display modes, so that the picture may be accurately displayed to the user.

For example, the display panel includes a pixel circuit. By setting the gate trigger signal and the reference voltage according to the display mode information using the processing circuit 213 according to the embodiments of the present disclosure, it is possible to input the gate driving signal Gate, the reset signal Reset and the data signal Vdata matched with the display mode to the pixel circuit, so that an image retention appearing on the display panel in different display modes may be mitigated.

In the embodiments of the present disclosure, the processing circuit 213 may control the GOA circuit to generate a gate driving signal according to the gate trigger signal. The processing circuit 213 may further control the source driving circuit to generate a driving voltage according to the reference voltage. In this case, the light emitting element of the pixel circuit may emit light under the driving of the gate driving signal and the driving voltage.

For example, the driving voltage may be a voltage value of a first level of the data signal. The source driving circuit may output the data signal Vdata based on the reference voltage.

For example, the GOA circuit may output the gate driving signal Gate and the reset signal Reset based on the gate trigger signal and a clock signal. A timing of the gate driving signal Gate and a timing of the reset signal Reset are related to a timing of the clock signal. The level of the gate driving signal Gate and the level of the reset signal Reset vary in the same manner as the level of the clock signal varies.

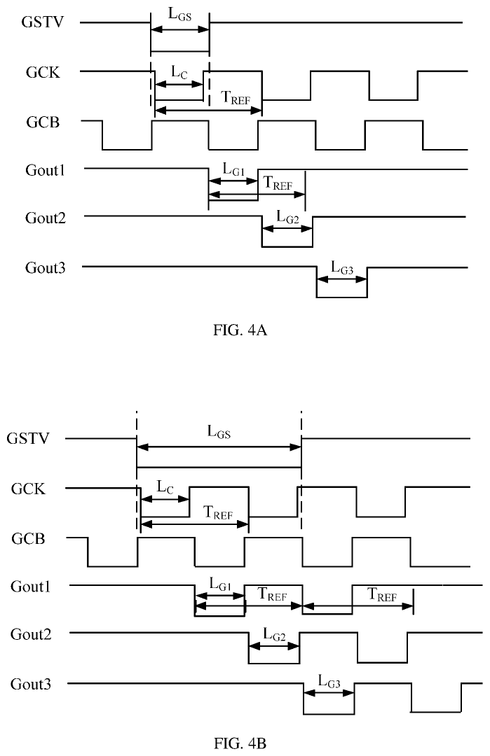

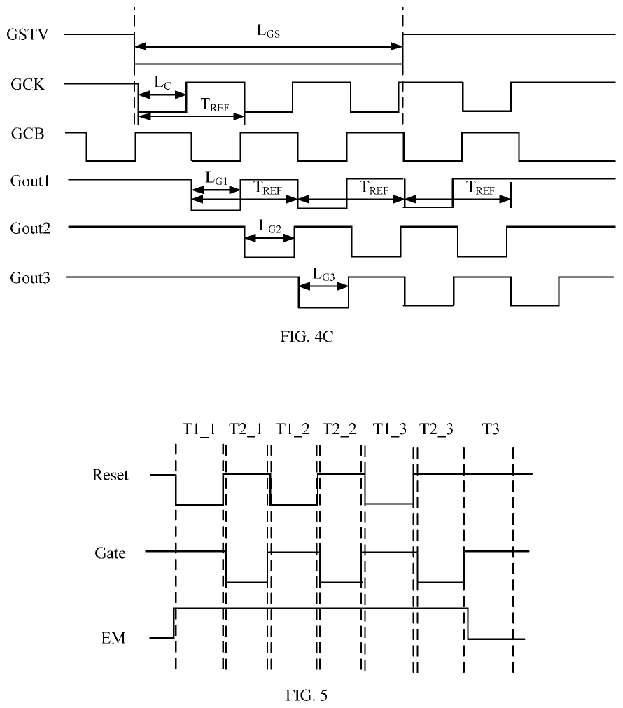

A process of driving the display panel will be described with reference to FIG. 3, FIG. 4A and FIG. 4C.

FIG. 3 shows a schematic structural diagram of a display apparatus according to an embodiment of the present disclosure.

As shown in FIG. 3, a display apparatus 300 includes a pixel unit 310, a gate driving circuit 320, and a display driving chip 330. The pixel unit 310 includes a plurality of pixel units 311 arranged in an array. Each pixel unit 311 may have a circuit structure as shown in FIG. 1.

The display driving chip 330 outputs a gate trigger signal and a clock signal to the gate driving circuit 320. The gate driving circuit 320 is a GOA circuit, which generates a gate driving signal Gate and a reset signal Reset according to the gate trigger signal and the clock signal.

The gate driving circuit 320 may perform progressive scanning on the pixel circuit 310 by using the gate driving signal Gate and the reset signal Reset. For example, the gate driving circuit 320 may horizontally scan a plurality of pixel units in a first row of pixel units in a direction from X to X′ by using a gate driving signal Gate1 and a reset signal Reset1.

The gate driving circuit 320 further collaborates with the clock signal to trigger the scanning of a next row of pixel units. For example, in a direction from Y to Y′, the gate driving circuit 320 may horizontally scan a plurality of pixel units in a second row of pixel units by using a gate driving signal Gate2 and a reset signal Reset2, and horizontally scan a plurality of pixel units in a third row of pixel units by using a gate driving signal Gate3 and a reset signal Reset3, thus completing the scanning of each row of pixel units in the pixel circuit 310.

FIG. 4A to FIG. 4C show timing of input signals and output signals of the gate driving circuit 320 in FIG. 3.

For example, the input signals of the GOA circuit include a gate trigger signal GSTV, a first clock signal GCK, and a second clock signal GCB. The output signals of the GOA circuit include a plurality of output signals Gout. For example, in a case that the pixel unit 310 shown in FIG. 3 includes n rows of pixel units, the GOA circuit includes n rows of GOA units, which may output n output signals Gout.

As shown in FIG. 4A to FIG. 4C, an output signal Gout1, an output signal Gout2 and an output signal Gout3 may be signals input to first three rows of pixel units of the pixel circuit 310. For example, the output signal Gout1 includes the gate driving signal Gate1 and the reset signal Reset1 that are input to the first row of pixel units in the pixel circuit 310 shown in FIG. 3. The output signal Gout2 includes the gate driving signal Gate2 and the reset signal Reset2 that are input to the second row of pixel units in the pixel circuit 310 shown in FIG. 3. The output signal Gout3 includes the gate driving signal Gate3 and the reset signal Reset3 that are input to the third row of pixel units in the pixel circuit 310 shown in FIG. 3.

The width of the first clock signal GCK at first level is identical to the width of the second clock signal GCB at first level. For example, a low level of the first clock signal GCK or a low level of the second clock signal GCB may serve as a valid level for turning on the transistor(s). The low level of the first clock signal GCK is alternated with the low level of the second clock signal GCB.

For example, a sum of a duration of a high level of the first clock signal GCK and a duration of a low level adjacent to the high level of the first clock signal GCK is a scanning cycle. The width of low level of the output signals Gout1, Gout2 and Gout3 is identical to the width of the low level of the first clock signal GCK in each scanning cycle. That is, a duration Lc of the low level of the first clock signal GCK is equal to the duration L_{G1} of the output signals Gout1, the duration L_{G2} of the output signal Gout2, and the duration L_{G3} of the low level of the output signal Gout3.

FIG. 4A shows a signal timing according to an embodiment of the present disclosure.

As shown in FIG. 4A, a start time of the low level of the gate trigger signal GSTV is close to a start time of the low level of the first clock signal GCK. For example, the start time of the low level of the gate trigger signal GSTV may be slightly earlier than the start time of the low level of the first clock signal GCK. As shown in the timing of the first clock signal GCK, the first clock signal GCK has one low level pulse occurred in a period from the start time of the low level of the gate trigger signal GSTV to an end time of the low level of the gate trigger signal GSTV. When the timing of the first clock signal GCK meets the above conditions, as shown in the timings of the output signals Gout1, Gout2 and Gout3, each of the output signals Gout1, Gout2 and Gout3 for scanning respective row of pixel units also has only one low level pulse during the displaying of each frame of data of the display picture. For example, when the transistors in the pixel unit are P-type transistors, the low levels of the output signals Gout1, Gout2 and Gout3 may serve as valid levels for turning on the transistor(s) in the pixel unit. The first levels of the output signals Gout1, Gout2 and Gout3 are sequentially shifted in time.

The start times of the first levels of the output signals Gout1, Gout2 and Gout3 are sequentially shifted in time, depending on the timing of the first clock signal GCK, the timing of the second clock signal GCB, and the number of rows of the pixel units. For example, an end time of the first level of the output signal Gout1 is a start time of the first level of the output signal Gout2, and an end time of the first level of the output signal Gout2 is a start time of the first level of the output signal Gout3.

For example, a time period during which the first clock signal GCK and the gate trigger signal GSTV are both at low level is taken as a time period during which the first clock signal GCK is first at low level. After the first clock signal GCK keeps at the first low level for a duration Lc (jumps to a high level), the output signal Gout1 for scanning the first row of pixel units jumps to low level. After the output signal Gout1 keeps at low level for a duration LG1, the output signal Gout1 jumps to high level, and the scanning of the first row of pixel units using the first frame of data is completed. After the output signal Gout1 jumps from low level to high level, the output signal Gout2 for scanning the second row of pixel units jumps to low level. After the output signal Gout2 keeps at low level for a duration LG2, the output signal Gout2 jumps to high level, and the scanning of the second row of pixel units using the first frame of data is completed. After the output signal Gout2 jumps from low level to high level, the level of the output signal Gout3 for scanning the third row of pixel units jumps to low level. After output signal Gout3 keeps at low level for a duration LG3, the output signal Gout3 jumps to high level, and the scanning of the third row of pixel units using the first frame of data is completed.

For example, a duration from the start time of the low level of the gate trigger signal GSTV to the end time of the low level of the gate trigger signal GSTV may be a duration LGs of the low level of the gate trigger signal GSTV, which is slightly greater than the duration Lc of the low level of the first clock signal GCK.

The timing of the output signal Gout shown in FIG. 4A corresponds to that of the gate driving signal Gate and the reset signal Reset shown in FIG. 1B. Based on the gate trigger signal GSTV shown in FIG. 4A as well as the gate driving signal Gate and the reset signal Reset output by the GOA circuit, the gate electrode of the driving transistor and the anode of the light emitting element may be initialized once respectively before the light emitting element emits light.

In the embodiments of the present disclosure, from the start time of the low level of the gate trigger signal GSTV to the end time of the low level of the gate trigger signal GSTV, one low level pulse appears in the timing of the first clock signal GCK. Accordingly, for the display of one frame of data of the display picture, only one low level pulse appears in each of the timings of the output signals Gout1, Gout2 and Gout3 for scanning the corresponding rows of pixel units respectively. The low level may serve as a valid level for turning on the transistor(s) in the pixel unit. Therefore, when the timing of the first clock signal GCK meets such conditions, a scanning cycle (a sum of the durations of adjacent high level and low level) of the first clock signal GCK may be considered as a reference scanning cycle TREF (as shown in FIG. 4A). It may be understood that for the display of one frame of data of the display picture, in a reference scanning cycle, one first level of the gate driving signal Gate and one first level of the reset signal Reset are applied to a row of pixel units. In this case, the duration LGs of the low level of the gate trigger signal GSTV may be recorded as 1GSTV.

Optionally, when the high level of the output signals Gout1, Gout2 and Gout3 serves as the first level for turning on the transistor(s) in the pixel unit, one high level appears in the timing of the first clock signal GCK from a start time of the high level of the gate trigger signal GSTV to an end time of the high level of the gate trigger signal GSTV. Accordingly, for the display of one frame of data of the display picture, only one high level appears in the timing of each of the output signals Gout1, Gout2 and Gout3 for scanning the corresponding rows of pixel units respectively. The duration Los of the high level of the gate trigger signal GSTV may be recorded as 1GSTV.

FIG. 4B shows a signal timing according to another embodiment of the present disclosure.

As shown in FIG. 4B, the start time of the first level of the gate trigger signal GSTV is close to the start time of the first level of the first clock signal GCK. From the start time of the low level of the gate trigger signal GSTV to the end time of the low level of the gate trigger signal GSTV, two low level pulses appear in the timing of the first clock signal GCK. When the timing of the first clock signal GCK meets the above conditions, for the display of one frame of data of the display picture, two low level pulses appear in the timing of each of the output signals Gout1, Gout2 and Gout3 for scanning the corresponding rows of pixel units respectively. The low level of the output signal may serve as a valid level for turning on the transistor(s) in the pixel unit. The start times of the first levels of the output signals Gout1, Gout2 and Gout3 are also sequentially shifted in the timing. For example, an end time of a first one of the first levels of the output signal Gout1 is a start time of a first one of the first levels of the output signal Gout2, and an end time of the first one of the first levels of the output signal Gout2 is a start time of a first one of the first levels of the output signal Gout3.

For example, the duration LGs of the low level of the gate trigger signal GSTV is slightly greater than a duration from a start time of a first one of the low levels of the first clock signal GCK to an end time of a second one of the low levels of the first clock signal GCK.

It may be understood that based on the gate trigger signal GSTV shown in FIG. 4B as well as the gate driving signal Gate and the reset signal Reset output by the GOA circuit, the gate electrode of the driving transistor and the anode of the light emitting element may be initialized twice respectively before the light emitting element emits light.

In this case, for the display of one frame of data of the display picture, two low level pulses of the gate driving signal Gate and two low level pulses of the reset signal Reset are respectively applied to a row of pixel units in two reference scanning cycles. In this case, the duration Los of the low level of the gate trigger signal GSTV may be recorded as 2GSTV.

FIG. 4C shows a signal timing according to still another embodiment of the present disclosure.

As shown in FIG. 4C, a start time of the low level of the gate trigger signal GSTV is close to a start time of the low level of the first clock signal GCK. From the start time of the low level of the gate trigger signal GSTV to the end time of the low level of the gate trigger signal GSTV, three low level pulses appear in the timing of the first clock signal GCK. When the first clock signal GCK meets the above conditions, for the display of one frame of data of the display picture, three low level pulses appear in the timing of each of the output signals Gout1, Gout2 and Gout3 for scanning the corresponding rows of pixel units respectively. The start times of the first levels of the output signals Gout1, Gout2 and Gout3 are also sequentially shifted in the timing. For example, an end time of a first one of the first levels of the output signal Gout1 is a start time of a first one of the first levels of the output signal Gout2, and an end time of the first one of the first levels of the output signal Gout2 is a start time of a first one of the first levels of the output signal Gout3.

For example, the duration LGs of the low level of the gate trigger signal GSTV is slightly greater than a duration from the start time of the first low level of the first clock signal GCK to the end time of the third low level of the first clock signal GCK.

It may be understood that based on the gate trigger signal GSTV shown in FIG. 4C as well as the gate driving signal Gate and the reset signal Reset output by the GOA circuit, the gate electrode of the driving transistor and the anode of the light emitting element may be respectively initialized three times before the light emitting element emits light.

In this case, for the display of one frame of data of the display picture, three low level pulses of the gate driving signal Gate and three low level pulses of the reset signal Reset are respectively applied to a row of pixel units in three reference scanning cycles. In this case, the duration LGs of the low level of the gate trigger signal GSTV may be recorded as 3GSTV.

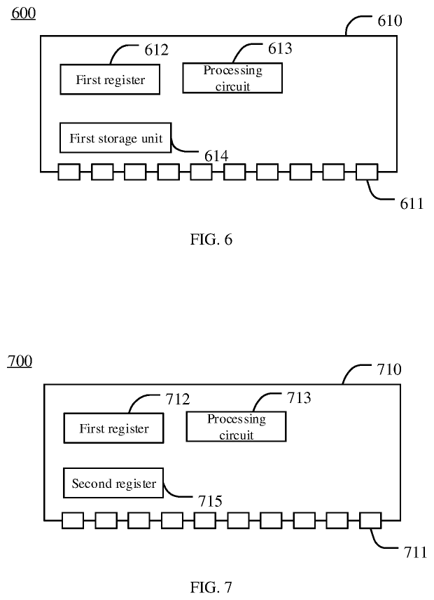

The timing of the output signal Gout when the duration LGs of the low level of the gate trigger signal GSTV is 3GSTV will be described below with reference to FIG. 5.

FIG. 5 shows a signal timing according to another embodiment of the present disclosure, in which a timing of signals applied to a row of pixel units in the pixel circuit is shown in FIG. 5.

As shown in FIG. 5, in phases T1_1, T1_2 and T1_3, the low level of the reset signal Reset serves as a valid level for turning on the transistor(s) of the pixel unit. In phases T2_1, T2_2 and T2_3, the low level of the gate driving signal Gate serves as a valid level for turning on the transistor(s) of the pixel unit.

For example, an operation process of pixel units in phases T1_1, T1_2 and T1_3 is similar to that in the initialization phase P1 shown in FIG. 1A and FIG. 1B. An operation process of pixel units in phases T2_1, T2_2 and T2_3 is similar to that in the data writing phase P1 shown in FIG. 1A and FIG. 1B. An operation process of pixel units in phase T3 is similar to that in the light emission phase P3 shown in FIG. 1A and FIG. 1B.

In the timing shown in FIG. 5, there are three initialization phases alternated with three data writing phases before the light emission phase. Therefore, in a case that the duration LGs of the low level of the gate trigger signal GSTV is 3GSSTV, the gate electrode of the driving transistor in the pixel unit may be reset twice (reset is performed in T2_1 and T2_2, and data writing is performed in phase T2_3) and the anode of the light emitting element may be initialized three times, based on the gate driving signal Gate and the reset signal Reset. In this way, the residual charge of the anode of the light emitting element may be sufficiently released, a possibility of drift in the driving transistor may be reduced, and the image retention in the display of the display panel may be mitigated.

According to the embodiments of the present disclosure, when the low level of the output signal Gout serves as a valid level for turning on the transistor(s) of the pixel unit, by setting the duration of the low level of the gate trigger signal GSTV as 2GSTV or 3GSSTV, it is possible to reset the gate electrode of the driving transistor in the pixel unit multiple times and initialize the anode of the light emitting element multiple times by using the gate driving signal Gate and the reset signal Reset in a plurality of reference scanning cycles before the light emission phase, so as to improve the image retention in the display of the display panel.

In some embodiments, the duration of the first level of the gate trigger signal GSTV is greater than or equal to a reference time difference. A time difference between a start time of the first level of the clock signal in a first scanning cycle of I scanning cycles and an end time of the first level of the clock signal in an I^{th} scanning cycle of the I scanning cycles is the reference time difference, where I is an integer greater than 1.

For example, at the end time of the first level of the clock signal, the level of the clock signal jumps from the first level to the second level.

When the low level of the output signal Gout serves as a valid level for turning on the transistor(s) of the pixel unit, the first level may be a low level, and the second level may be a high level. When the high level of the output signal Gout serves as a valid level for turning on the transistor(s) of the pixel unit, the first level may be a high level, and the second level may be a low level.

For example, the scanning cycle is the reference scanning cycle. A time difference between a start time of the first level of the clock signal in the first one of a plurality of reference scanning cycles and an end time of the first level of the clock signal in the last one of the plurality of reference scanning cycles is the reference time difference. Accordingly, from the start time to the end time of the first level of the gate trigger signal GSTV, at least two first level pulses appear in the clock signal. For example, the timings of the gate trigger signal GSTV, the first clock signal GCK and the output signal Gout are shown in FIG. 4B and FIG. 4C.

For example, I may be 2, 3, 4 and 5. For example, the duration of the first level of the gate trigger signal GSTV may be 2GSTV, 3GSSTV, 4GSTV and 5GSTV. From the start time to the end time of the first level of the gate trigger signal GSTV, two, three, four or five first level pulses may appear in the clock signal.

Accordingly, the duration of the first level of the gate trigger signal GSTV is greater than or equal to a gate time difference. A time difference between a start time of the first level of the gate driving signal in a first scanning cycle of I scanning cycles and an end time of the first level of the gate driving signal in an I^{th} scanning cycle of the I scanning cycles is the gate time difference.

For example, in a plurality of reference scanning cycles, a time difference between a start time of the first level of the clock signal in a first reference scanning cycle and an end time of the first level of the clock signal in a last reference scanning cycle is the reference time difference. Accordingly, for the display of one frame of data of the display picture, at least two first level pulses appear in the gate driving signal for scanning a row of pixel units. For example, the timings of the gate trigger signal GSTV, the first clock signal GCK and the output signal Gout are shown in FIG. 4B and FIG. 4C.

As the duration of the first level of the gate trigger signal GSTV is set to be greater than or equal to the reference time difference, the gate driving signal Gate output by the GOA circuit based on the gate trigger signal GSTV may reset the gate electrode of the driving transistor at least once (the last one of the first levels of the gate driving signal Gate is used for data writing), so that the drift of the driving transistor may be alleviated. The reset signal Reset output by the GOA circuit based on the gate trigger signal GSTV may initialize each row of pixel units at least twice, so that the anode of the light emitting element may be initialized sufficiently, the residual charge of the anode of the light emitting element may be released sufficiently, thereby alleviating the image retention in the display of the display panel.

In some embodiments, the display mode information includes an HBM mode and an AOD mode, and the duration includes a first duration and a second duration. When it is determined that the display mode information is the HBM mode, the processing circuit 213 shown in FIG. 2 may write the first duration into the first register 212 shown in FIG. 2. When it is determined that the display mode information is the AOD mode, the processing circuit 213 may write the second duration into the first register 212. The second duration is greater than the first duration.

For example, if a long duration of the first level of the gate trigger signal GSTV is set, the gate electrode of the driving transistor may be reset and the anode of the light emitting element may be initialized multiple times before the light emitting element emits light, so that the image retention may be mitigated. However, if the gate electrode of the driving transistor is reset too many times, some of the pixel units in the pixel circuit may have a difference in gate voltage of driving transistor, resulting in non-uniform display brightness of the display panel, a blur edge may appear visually.

For the AOD mode, as the display pictures are typically solid color pictures, there will be no obvious blur edges visually in a case of non-uniform display brightness of the display panel, and an impact on user experience is small. For the HBM mode, the display pictures are typically complex pictures and require higher brightness of the display panel. Therefore, the processing circuit 213 may write the first duration into the first register 212, set the duration of the first level of the gate trigger signal GSTV, and control the number of times of resetting the gate electrode the driving transistor and the number of times of initializing the anode of the light emitting element in the HBM mode, so as to balance the image retention and the blur edge in the display picture.

On the premise that the blur edge in the AOD mode does not affect the user's visual experience, the duration of the first level of the gate trigger signal GSTV in the AOD mode may be set as the second duration greater than the first duration, so that the image retention may be mitigated. On the premise that the blur edge in the HBM mode would affect the user's visual experience, the duration of the first level of the gate trigger signal GSTV in the HBM mode may be set as the first duration less than the second duration, so that the image retention may be mitigated without causing blur edges.

For example, when the display mode of the display panel is set as the HBM mode, the processing circuit 213 may write the first duration into the first register 212, and set the duration of the first level of the gate trigger signal GSTV as the first duration, so that the first level of the gate driving signal and the first level of the reset signal may alternately appear A times to reset the gate electrode of the driving transistor A-1 times and initiate the anode of the light emitting element A times before the light emission phase. When the display mode of the display panel is set as the AOD mode, the processing circuit 213 may write the second duration into the first register 212, and set the duration of the first level of the gate trigger signal GSTV as the second duration, so that the first level of the gate driving signal and the first level of the reset signal may alternately appear B times to reset the gate electrode of the driving transistor B-1 times and initiate the anode of the light emitting element B times before the light emission phase.

For example, as the second duration is greater than the first duration, a relationship between A and B may be 1<A<B.

In the embodiments of the present disclosure, the display mode information further includes a normal mode. When it is determined that the display mode information is the normal mode, the processing circuit 213 writes the first duration into the first register 212.

Since a type of display content on the display panel in the normal mode is similar to that in the HBM mode, the processing circuit 213 may write the first duration into the first register 212 and the duration of the first level of the gate trigger signal GSTV in the normal mode may be set to be the same as that in the HBM mode. For example, when the display mode of the display panel is set as the normal mode, the duration may also be set as the first duration, so that the first level of the gate driving signal and the first level of the reset signal may alternately appear A times to reset the gate electrode of the driving transistor A-1 times and initiate the anode of the light emitting element A times before the light emission phase.

In the embodiments of the present disclosure, the first duration is greater than or equal to a first reference time difference, and the second duration is greater than or equal to a second reference time difference.

For example, a time difference between a start time of the first level of the clock signal in a first scanning cycle of M scanning cycles and an end time of the first level of the clock signal in an M^{th} scanning cycle of the M scanning cycles is the first reference time difference. A time difference between a start time of the first level of the clock signal in a first scanning cycle of N scanning cycles and an end time of the first level of the clock signal in an N^{th} scanning cycle of the N scanning cycles is the second reference time difference. M<N, and M and N are integers greater than 1.

For example, the scanning cycle may be a reference scanning cycle. As M<N, the second reference time difference is greater than the first reference time difference.

For example, the first duration is greater than or equal to the first reference time difference, the duration is set as the first duration, and the first level of the gate driving signal and the first level of the reset signal may alternately appear M times before the light emission phase. The second duration is greater than or equal to the second reference time difference, the duration is set as the second duration, and the first level of the gate driving signal and the first level of the reset signal may alternately appear N times before the light emission phase.

In this case, the number of times the first level of the gate driving signal and the first level of the reset signal alternately appear within the second duration is greater than the number of times the first level of the gate driving signal and the first level of the reset signal alternately appear within the first duration.

For each of different display modes, a corresponding duration of the first level of the gate trigger signal GSTV for different display modes is set, so that a gate driving signal having a respective timing and a reset signal having a respective timing are obtained, in order to reset the gate electrode of the driving transistor for corresponding times and initiate the anode of the light emitting element for corresponding times. In this way, it is possible to mitigate image retention by different operations in different display modes respectively.

For example, for the AOD mode in which a simple picture is displayed, the duration of the first level of the gate trigger signal GSTV may be set as the second duration, so that the gate electrode of the driving transistor may be reset more times and the anode of the light emitting element may be initialized more times, and the image retention may be improved sufficiently. For the normal mode and the HBM mode in which a complex picture is displayed, the duration of the first level of the gate trigger signal GSTV may be set as the first duration, so that the gate electrode of the driving transistor may be reset fewer times and the anode of the light emitting element may be initialized fewer times, and the image retention may be mitigated without causing blur edges.

In the embodiments of the present disclosure, a relationship between M, N and I may be M<N≤I. Therefore, a value range of N may be 3, 4 and 5, and a value range of M may be 2, 3 and 4. For example, in the AOD mode, N may be 3. Accordingly, in the normal mode and the HBM mode, M may be 2. For example, when N is 3, the timings of the gate trigger signal GSTV, the gate driving signal and the reset signal may be as shown in FIG. 4C. When M is 2, the timings of the gate trigger signal GSTV, the gate driving signal and the reset signal may be as shown in FIG. 4B.

In some embodiments, the processing circuit 213 shown in FIG. 2 may further receive a display mode switching request through the plurality of pins, and the display mode switching request contains a target display mode. The processing circuit 213 reads a current duration of the first level of the gate trigger signal GSTV from the first register 212 shown in FIG. 2. When it is determined that a target duration corresponding to the target display mode is different from the current duration, the processing circuit 213 writes the target duration into the first register 212, and generates a gate trigger signal GSTV based on the target duration stored in the first register 212.

For example, a default display mode of the display panel may be the normal mode, and the duration of the first level of the gate trigger signal GSTV corresponding to the normal mode may be the first duration. After the display is turned on, the duration of the first level of the gate trigger signal GSTV may be set as the first duration by default. After a display mode switching request is received, the current duration is determined as the first duration. The target display mode contained in the display mode switching request may be the AOD mode, and the duration of the first level of the gate trigger signal GSTV corresponding to the AOD mode may be the second duration. Therefore, when it is determined that the target display mode corresponds to the second duration and the current duration mode is the first duration mode, the processing circuit 213 writes the second duration into the first register 212, and generates a gate trigger signal GSTV based on the second duration stored in the first register 212.

For example, the display driving chip 210 shown in FIG. 2 may have a built-in default running program that generates a gate driving signal based on the duration being the first duration. When the processing circuit 213 modifies the duration stored in the first register 212 to the second duration, a running program that generates a gate driving signal based on the second duration may be input from external to the display driving chip 210. For example, an external host may send a mode switching instruction and a corresponding running program to the display driving chip 210 through Mobile Industry Processor Interface (MIPI) protocol. For example, the processing circuit 213 may further receive the mode switching instruction and the corresponding running program from the external host based on the MIPI protocol through the pins 211.

When switching the AOD mode back to the normal mode, the processing circuit 213 may modify the duration stored in the first register 212 from the second duration to the first duration, and generate a gate trigger signal GSTV based on the built-in default running program.

Since the first level of the gate trigger signal has different durations, some of the driving transistors in the pixel circuit may have a difference in voltage of gate electrode, resulting in different brightness of the display picture for different durations. For example, for a same picture, the display brightness corresponding to the duration of 3GSTV is greater than the display brightness corresponding to the duration of 2GSTV, and the display brightness corresponding to the duration of 2GSTV is greater than the display brightness corresponding to the duration of 1GSTV. For this case, it is possible to pre-store gamma voltages corresponding to different durations in the display driving chip 210 by Gamma tuning.

After the processing circuit 213 writes the duration into the first register 212, the pixel circuit may be driven according to the gamma voltage corresponding to the duration pre-stored in the display driving chip 210, so that the duration corresponding to the display brightness may identical to the duration corresponding to the gamma voltage, thereby ensuring that the gamma voltage is matched with the display brightness of the display panel in different display modes.

In the embodiments of the present disclosure, when it is determined that the target duration corresponding to the target display mode is identical to the current duration, the processing circuit 213 generates a gate trigger signal GSTV based on the current duration stored in the first register 212.

For example, the default display mode of the display panel may be the normal mode, and the duration of the first level of the gate trigger signal GSTV corresponding to the normal mode may be the first duration. After the display is turned on, the first duration may be stored in the first register 212 by default. After a display mode switching request is received, the processing circuit 213 determines the current duration as the first duration. The target display mode contained in the display mode switching request may be the HBM mode, and the duration of the first level of the gate trigger signal corresponding to the HBM mode is the first duration. Therefore, when it is determined that the target display mode corresponds to the first duration and the current duration mode is also the first duration mode, the processing circuit 213 may generate a gate trigger signal GSTV based on the first duration stored by default in the first register 212. In this case, the processing circuit 213 may generate a gate driving signal GSTV based on the built-in default running program in the display driving chip 210.

For example, after receiving the display mode switching request, the processing circuit 213 determines that the current duration is the first duration. The target display mode contained in the display mode switching request may be the AOD mode, and the duration of the first level of the gate trigger signal corresponding to the AOD mode may be the second duration. Therefore, when it is determined that the target display mode corresponds to the second duration and the current duration mode is the first duration mode, the processing circuit 213 modifies the first duration stored by default in the first register 212 to the second duration, and generates a gate trigger signal based on the received running program corresponding to the second duration.

When switching from the AOD mode to the normal mode or the HBM mode, the processing circuit 213 may modify the second duration stored in the first register 212 to the first duration, and generate a gate trigger signal GSTV based on the built-in default running program.

For example, the first duration may be 2GSTV, and the timings of the gate trigger signal GSTV, the gate driving signal and the reset signal may be as shown in FIG. 4B. The second duration may be 3GSTV, and the timings of the gate trigger signal GSTV, the gate driving signal and the reset signal may be as shown in FIG. 4C.

FIG. 6 shows a schematic structural diagram of a display driving device according to another embodiment of the present disclosure.

As shown in FIG. 6, a display driving device 600 may include a display driving chip 610.

In the embodiments of the present disclosure, the display driving chip 610 includes a plurality of pins 611, a first register 612, a processing circuit 613, and a first storage unit 614.

An operation performed by the processing circuit 613 is similar to that performed by the processing circuit 213 shown in FIG. 2, a function of the first register 612 is similar to that of the first register 212 shown in FIG. 2, and a function of the pins 611 is similar to that of the pins 211 shown in FIG. 2, which will not be repeated here.

In the embodiments of the present disclosure, a reference voltage is stored in the first storage unit 61. For example, a reference voltage corresponding to the first duration and a reference voltage corresponding to the second duration are stored in the first storage unit 614. A running program corresponding to the first duration and a running program corresponding to the second duration may also be stored in the first storage unit 614.

The processing circuit 613 may generate a gate driving signal GSTV based on the first duration stored in the first register 612 and the running program corresponding to the first duration stored in the first storage unit 614. The processing circuit 613 may further generate a gate driving signal GSTV based on the second duration stored in the first register 612 and the running program corresponding to the second duration stored in the first storage unit 614.

FIG. 7 shows a schematic structural diagram of a display driving device according to another embodiment of the present disclosure.

As shown in FIG. 7, a display driving device 700 may include a display driving chip 710.

In the embodiments of the present disclosure, the display driving chip 710 includes a plurality of pins 711, a first register 712, a processing circuit 713, and a second register 715.

An operation performed by the processing circuit 713 is similar to that performed by the processing circuit 213 shown in FIG. 2, a function of the first register 712 is similar to that of the first register 212 shown in FIG. 2, and a function of the pins 711 is similar to that of the pins 211 shown in FIG. 2, which will not be repeated here.

In the embodiments of the present disclosure, the first register 712 is configured to store the first duration, and the second register 715 is configured to store the second duration. The first duration is less than the second duration.

The processing circuit 713 may receive a display mode switching request through the plurality of pins 711, where the display mode switching request contains a target display mode; generates a gate trigger signal based on the first duration stored in the first register 712 when it is determined that the target display mode is the HBM mode; and generate a gate trigger signal based on the second duration stored in the second register 715 when it is determined that the target display mode is the AOD mode.

For example, the first register 712 and the second register 715 are provided inside the display driving chip 710 to control the duration of the first level of the gate trigger signal. For example, the first duration is stored in a physical storage space of the first register 712, and an address of the first register 712 is bound to the normal mode and the HBM mode. The second duration is stored in a physical storage space of the second register 715, and an address of the second register 715 is bound to the AOD mode.

After the display is turned on, the default display mode of the display panel may be the normal mode, and the duration of the first level of the gate trigger signal may be set as the first duration by default. After receiving a display mode switching request, the display driving device 700 in the display determines that the target display mode contained in the display mode switching request may be the AOD mode. The display driving device 700 in the display may read the second duration stored in the second register 715 based on the address of the second register 715 bound to the AOD mode, and generate a gate trigger signal based on the corresponding running program.

When switching from the AOD mode to the normal mode or the HBM mode, the display driving device 700 may read the first duration stored in the first register 712 based on the address of the first register 712 bound to the normal mode and the HBM mode, and generate a gate trigger signal based on the corresponding running program.

In the embodiments of the present disclosure, the processing circuit 713 may further read the reference voltage corresponding to the duration from the first storage unit, and drive the pixel circuit using the reference voltage together with the gate trigger signal. For example, the first storage unit may be a storage unit inside the display driving device 700, and the first storage unit is not shown in FIG. 7.

FIG. 8 shows a schematic structural diagram of a display driving device according to another embodiment of the present disclosure.

As shown in FIG. 8, a display driving device 800 may include a display driving chip 810 and a second storage unit 820.

In the embodiments of the present disclosure, the display driving chip 810 includes a plurality of pins 811, a first register 812, and a processing circuit 813.

An operation performed by the processing circuit 813 is similar to that performed by the processing circuit 213 shown in FIG. 2, a function of the first register 812 is similar to that of the first register 212 shown in FIG. 2, and a function of the pins 811 is similar to that of the pins 211 shown in FIG. 2, which will not be repeated here.

In the embodiments of the present disclosure, the second storage unit 820 is configured to store a reference voltage. The processing circuit 813 may read the reference voltage corresponding to the duration from the second storage unit 820.

For example, the second storage unit 820 may further store data related to touch firmware/Demura (for eliminating mura) or other circuits.

For example, the second storage unit 820 may be a flash memory. The second storage unit 820 is located outside the display driving chip 810.

For example, the display driving chip 810 may communicate with the second storage unit 820 through communication protocols such as Serial Peripheral Interface (SPI) and Serial Transmission Bus (INTER IC BUS, I2C), thereby calling the data stored in the second storage unit 820.

For example, the flash memory may achieve multiple data erasures/writes, so that multiple Gamma tuning may be performed for different display modes, and the obtained gamma voltages may be stored in the flash memory.

For example, the processing circuit 813 may receive a mode switching instruction and a corresponding running program from an external host based on the MIPI protocol through the pins 811.

The first storage unit inside the display driving chip 810 further stores a default running program, which corresponds to the first duration and is used to enter the normal mode and the HBM mode. The first storage unit is not shown in FIG. 8. After the display is turned on, the duration of the first level of the gate trigger signal may be set as the first duration by default. After receiving a display mode switching request, the processing circuit 813 in the display determines that the current duration is the first duration. The target display mode contained in the display mode switching request may be the AOD mode, and the duration of the first level of the gate trigger signal corresponding to the AOD mode may be the second duration. Therefore, when it is determined that the target display mode corresponds to the second duration and the current duration mode is the first duration mode, the processing circuit 813 modifies the default set duration of the first level of the gate trigger signal to the second duration, and generates a gate trigger signal based on the received running program corresponding to the second duration.

When switching from the AOD mode to the normal mode or the HBM mode, the processing circuit 813 may modify the duration of the first level of the gate trigger signal from the second duration to the first duration, and generate a gate trigger signal based on the built-in default running program.

In the embodiments of the present disclosure, the processing circuit 813 may further read the reference voltage corresponding to the duration from the second storage unit 820, and drive the pixel circuit using the reference voltage together with the gate trigger signal.

In the embodiments of the present disclosure, the second storage unit 820 is further configured to store the duration of the first level of the gate trigger signal corresponding to the display mode information. The processing circuit 813 may read the duration from the second storage unit 820 and write the duration into the first register 812.

For example, the second storage unit 820 may further store a running program corresponding to the duration.

For example, the processing circuit 813 may receive the mode switching instruction from the external host based on the MIPI protocol through the pins 811. The processing circuit 813 reads the first or second duration corresponding to the display mode from the second storage unit 820, and writes the read first or second duration into the first register 812. The processing circuit 813 may read the running program corresponding to the duration from the second storage unit 820, generate a gate trigger signal, read the reference voltage corresponding to the duration from the second storage unit 820, and drive the pixel circuit using the reference voltage together with the gate trigger signal.

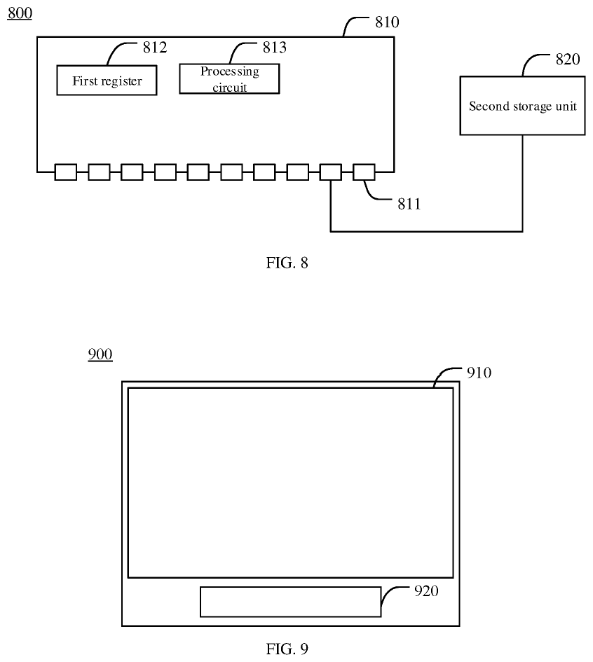

FIG. 9 shows a block diagram of a display apparatus according to an embodiment of the present disclosure.

As shown in FIG. 9, a display apparatus 900 may include a display panel 910 and a display driving device 920.

The display driving device 920 is configured to drive the display panel 910.

The display driving device 920 may be the display driving device 200, the display driving device 600, the display driving device 700, or the display driving device 800 described above, and will not be described in detail here.

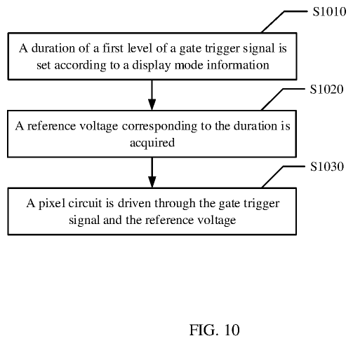

FIG. 10 shows a flowchart of a display driving method according to an embodiment of the present disclosure.

As shown in FIG. 10, the driving method may include operation S1010 to operation S1030.

In operation S1010, a duration of a first level of a gate trigger signal is set according to a display mode information.

In operation S1020, a reference voltage corresponding to the duration is acquired.

In operation S1030, a pixel circuit is driven through the gate trigger signal and the reference voltage.

In the embodiments of the present disclosure, operation S1010 to operation S1030 are similar to the operations performed by the processing circuit 213 described above, which will not be repeated here.

For example, the duration is greater than or equal to a reference time difference. A time difference between a start time of a first level of a clock signal in a first scanning cycle of I scanning cycles and an end time of the first level of the clock signal in an I^{th} scanning cycle of the I scanning cycles is the reference time difference, where I is an integer greater than 1.

For example, the display mode information includes an HBM mode and an AOD mode, and the duration includes a first duration and a second duration. Setting the duration of the first level of the gate trigger signal according to the display mode information in operation S1010 may include: setting the duration as the first duration when it is determined that the display mode information is the HBM mode; and setting the duration as the second duration when it is determined that the display mode information is the AOD mode. The second duration is greater than the first duration.

For example, the display mode information further includes a normal mode. Setting the duration of the first level of the gate trigger signal according to the display mode information in operation S1010 may further include: setting the duration as the first duration when it is determined that the display mode information is the normal mode.

For example, the first duration is greater than or equal to a first reference time difference, and the second duration is greater than or equal to a second reference time difference. A time difference between a start time of the first level of the clock signal in a first scanning cycle of M scanning cycles and an end time of the first level of the clock signal in an M^{th} scanning cycle of M the scanning cycles is the first reference time difference. A time difference between a start time of the first level of the clock signal in a first scanning cycle of N scanning cycles and an end time of the first level of the clock signal in an N^{th} scanning cycle of N scanning cycles is the second reference time difference. M<N, and M and N are integers greater than 1.

For example, setting the duration of the first level of the gate trigger signal according to the display mode information in operation S1010 may include: acquiring a current duration of the first level of the gate trigger signal and a target display mode contained in a display mode switching request in response to the display mode switching request being received; and modifying the current duration to a target duration corresponding to the target display mode when it is determined that the target duration is different from the current duration.

For example, setting the duration of the first level of the gate trigger signal according to the display mode information in operation S1010 may include: acquiring a current duration of the first level of the gate trigger signal and a target display mode contained in a display mode switching request in response to the display mode switching request being received; and maintaining the current duration when it is determined that a target duration corresponding to the target display mode is consistent with the current duration.

For example, driving the pixel circuit by the gate trigger signal and the reference voltage in operation S1030 may include: generating a gate driving signal according to the gate trigger signal; generating a driving voltage according to the reference voltage; and driving the pixel circuit through the gate driving signal and the driving voltage.

For example, the duration is greater than or equal to a gate time difference. A time difference between a start time of the first level of the gate driving signal in a first scanning cycle of I scanning cycles and an end time of the first level of the gate driving signal in an I^{th} scanning cycle of the I scanning cycles is the gate time difference.

The flowcharts and block diagrams in the drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

The embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A display driving device comprising a display driving chip, the display driving chip comprising:
a first register;
a plurality of pins; and
a processing circuit configured to:
write a duration of a first level of a gate trigger signal corresponding to a display mode information into the first register, wherein the gate trigger signal jumps from the first level to a second level at an end time of the first level;
generate the gate trigger signal based on the duration stored in the first register;
acquire a reference voltage corresponding to the duration; and
output the gate trigger signal and the reference voltage through the plurality of pins.

2. The display driving device according to claim 1, wherein the processing circuit is further configured to:
receive a display mode switching request through the plurality of pins, wherein the display mode switching request contains a target display mode;
read a current duration of the first level of the gate trigger signal from the first register;
write a target duration corresponding to the target display mode into the first register in response to determining that the target duration is different from the current duration; and
generate the gate trigger signal based on the target duration stored in the first register.

3. The display driving device according to claim 1, wherein the processing circuit is further configured to:
receive a display mode switching request through the plurality of pins, wherein the display mode switching request contains a target display mode;
read a current duration of the first level of the gate trigger signal from the first register; and
generate the gate trigger signal based on the current duration stored in the first register, in response to determining that a target duration corresponding to the target display mode is identical to the current duration.

4. The display driving device according to claim 1, wherein the display driving chip further comprises a second register configured to store a second duration;
wherein the first register is further configured to store a first duration less than the second duration; and
wherein the processing circuit is further configured to:
receive a display mode switching request through the plurality of pins, wherein the display mode switching request contains a target display mode;
generate the gate trigger signal based on the first duration stored in the first register, in response to determining that the target display mode is a high brightness monitor mode; and
generate the gate trigger signal based on the second duration stored in the second register, in response to determining that the target display mode is an always on display mode.

5. The display driving device according to claim 1, wherein the display driving chip further comprises a first storage unit configured to store the reference voltage; and
wherein the processing circuit is further configured to read the reference voltage corresponding to the duration from the first storage unit.

6. The display driving device according to claim 1, further comprising:
a second storage unit configured to store a reference voltage;
wherein the processing circuit is further configured to read the reference voltage corresponding to the duration from the second storage unit.

7. The display driving device according to claim 6, wherein the second storage unit is further configured to store the duration of the first level of the gate trigger signal corresponding to the display mode information; and
wherein the processing circuit is further configured to read the duration from the second storage unit and write the duration into the first register.

8. The display driving device according to claim 1, wherein the duration is greater than or equal to a reference time difference; and
wherein a time difference between a start time of a first level of a clock signal in a first scanning cycle of I scanning cycles and an end time of a first level of the clock signal in an I^{th} scanning cycle of the I scanning cycles is the reference time difference, where I is an integer greater than 1.

9. The display driving device according to claim 1, wherein the processing circuit is further configured to:
write a first duration into the first register in response to determining that the display mode information is a high brightness monitor mode; and
write a second duration into the first register in response to determining that the display mode information is an always on display mode;
wherein the second duration is greater than the first duration.

10. The display driving device according to claim 9, wherein the processing circuit is further configured to:
write the first duration into the first register in response to determining that the display mode information is a normal mode.

11. The display driving device according to claim 9, wherein the first duration is greater than or equal to a first reference time difference, and the second duration is greater than or equal to a second reference time difference; and
wherein a time difference between a start time of a first level of a clock signal in a first scanning cycle of M scanning cycles and an end time of a first level of the clock signal in an M^{th} scanning cycle of the M scanning cycles is the first reference time difference; and a time difference between a start time of a first level of the clock signal in a first scanning cycle of N scanning cycles and an end time of a first level of the clock signal in an N^{th} scanning cycle of the of N scanning cycles is the second reference time difference, where M<N, and M and N are integers greater than 1.

12. A display apparatus, comprising:
a display panel; and
the display driving device of claim 1, configured to drive the display panel.

13. A display driving method for driving a pixel circuit, comprising:
setting a duration of a first level of a gate trigger signal according to a display mode information, wherein the gate trigger signal jumps from the first level to a second level at an end time of the first level;
acquiring a reference voltage corresponding to the duration; and
driving the pixel circuit through the gate trigger signal and the reference voltage.

14. The method according to claim 13, wherein the duration is greater than or equal to a reference time difference; and
wherein a time difference between a start time of a first level of a clock signal in a first scanning cycle of I scanning cycles and an end time of a first level of the clock signal in an I^{th} scanning cycle of the I scanning cycles is the reference time difference, and I is an integer greater than 1.

15. The method according to claim 13, wherein the display mode information comprises a high brightness monitor mode and an always on display mode, and the duration comprises a first duration and a second duration; and wherein the setting a duration of a first level of a gate trigger signal according to a display mode information comprises:
setting the duration as the first duration in response to determining that the display mode information is the high brightness monitor mode; and
setting the duration as the second duration in response to determining that the display mode information is the always on display mode;
wherein the second duration is greater than the first duration.

16. The method according to claim 15, wherein the display mode information further comprises a normal mode; and wherein the setting a duration of a first level of a gate trigger signal according to a display mode information further comprises:
setting the duration as the first duration in response to determining that the display mode information is the normal mode.

17. The method according to claim 15, wherein the first duration is greater than or equal to a first reference time difference, and the second duration is greater than or equal to a second reference time difference; and
wherein a time difference between a start time of a first level of a clock signal in a first scanning cycle of M scanning cycles and an end time of a first level of the clock signal in an M^{th} scanning cycle of the M scanning cycles is the first reference time difference; and a time difference between a start time of a first level of a clock signal in a first scanning cycle of N scanning cycles and an end time of a first level of the clock signal in an N^{th} scanning cycle of the N scanning cycles is the second reference time difference, where M<N, and M and N are integers greater than 1.

18. The method according to claim 13, wherein the setting a duration of a first level of a gate trigger signal according to a display mode information comprises:
acquiring a current duration of the first level of the gate trigger signal and a target display mode contained in a display mode switching request, in response to the display mode switching request being received; and
modifying the current duration to a target duration corresponding to the target display mode, in response to determining that the target duration is different from the current duration.

19. The method according to claim 13, wherein the setting a duration of a first level of a gate trigger signal according to a display mode information comprises:
acquiring a current duration of the first level of the gate trigger signal and a target display mode contained in a display mode switching request, in response to the display mode switching request being received; and
maintaining the current duration in response to determining that a target duration corresponding to the target display mode is identical to the current duration.

20. The method according to claim 13, wherein the driving the pixel circuit through the gate trigger signal and the reference voltage comprises:
generating a gate driving signal according to the gate trigger signal;
generating a driving voltage according to the reference voltage; and
driving the pixel circuit through the gate driving signal and the driving voltage;
wherein the duration is greater than or equal to a gate time difference; and
wherein a time difference between a start time of a first level of the gate driving signal in a first scanning cycle of I scanning cycles and an end time of a first level of the gate driving signal in an I^{th} scanning cycle of the I scanning cycles is the gate time difference.

21. (canceled)
